(19) United States
(12) Patent Application Publication
(10) Pub. No.: US 2025/0113372 A1
(43) Pub. Date: Apr. 3, 2025

(54) HANDLING OF CANDIDATE RESOURCES

(71) Applicant: QUALCOMM Incorporated, San Diego, CA (US)

(72) Inventors: Ran BERLINER, Kfar Aviv (IL); Peer BERGER, Hod Hasharon (IL); Yevgeny ZAGALSKY, Karmey Yosef (IL); Shay LANDIS, Hod Hasharon (IL); Eitan YERUSHALMI, Tel Aviv (IL); David JACOBIAN, Herzliya (IL)

(21) Appl. No.: 18/477,944

(22) Filed: Sep. 29, 2023

(51) Int. Cl. H04W 72/54; H04W 72/04; H04W 72/20

(52) U.S. Cl. CPC H04W 72/54; H04W 72/04; H04W 72/20

(57) ABSTRACT

Various aspects of the present disclosure generally relate to wireless communication. In some aspects, a user equipment (UE) may identify one or more quality metrics associated with one or more respective control channel elements (CCEs) of a first set of candidate resources that partially overlaps with a second set of candidate resources, wherein the first set of candidate resources is associated with a first aggregation level and the second set of candidate resources is associated with a second aggregation level. The UE may prune the second set of candidate resources based at least in part on a shaping pattern of the one or more quality metrics satisfying a quality tolerance threshold. Numerous other aspects are described.

### FIELD OF THE DISCLOSURE

Aspects of the present disclosure generally relate to wireless communication and to techniques and apparatuses for handling of candidate resources.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories, one or more processors coupled to the one or more memories, and instructions stored in the one or more memories and executable by the one or more processors. The instructions may be executable by the one or more processors to cause the UE to identify one or more quality metrics associated with one or more respective control channel elements (CCEs) of a first set of candidate resources that partially overlaps with a second set of candidate resources, wherein the first set of candidate resources is associated with a first aggregation level and the second set of candidate resources is associated with a second aggregation level. The instructions may be executable by the one or more processors to cause the UE to prune the second set of candidate resources based at least in part on a shaping pattern of the one or more quality metrics satisfying a quality tolerance threshold.

Some aspects described herein relate to a UE for wireless communication. The UE may include one or more memories, one or more processors coupled to the one or more memories, and instructions stored in the one or more memories and executable by the one or more processors. The instructions may be executable by the one or more processors to cause the UE to identify a first set of candidate resources that fully overlaps with one or more second sets of candidate resources, wherein the first set of candidate resources is associated with a first aggregation level and the one or more second sets of candidate resources are associated with a second aggregation level, wherein the first aggregation level is greater than the second aggregation level. The instructions may be executable by the one or more processors to cause the UE to perform, based at least in part on the first aggregation level being greater than the second aggregation level, a first decode operation on the first set of candidate resources before selectively performing one or more second decode operations on the one or more second sets of candidate resources.

Some aspects described herein relate to a method of wireless communication performed by a UE. The method may include identifying one or more quality metrics associated with one or more respective CCEs of a first set of candidate resources that partially overlaps with a second set of candidate resources, wherein the first set of candidate resources is associated with a first aggregation level and the second set of candidate resources is associated with a second aggregation level. The method may include pruning the second set of candidate resources based at least in part on a shaping pattern of the one or more quality metrics satisfying a quality tolerance threshold.

Some aspects described herein relate to a method of wireless communication performed by a UE. The method may include identifying a first set of candidate resources that fully overlaps with one or more second sets of candidate resources, wherein the first set of candidate resources is associated with a first aggregation level and the one or more second sets of candidate resources are associated with a second aggregation level, wherein the first aggregation level is greater than the second aggregation level. The method may include performing, based at least in part on the first aggregation level being greater than the second aggregation level, a first decode operation on the first set of candidate resources before selectively performing one or more second decode operations on the one or more second sets of candidate resources.

Some aspects described herein relate to a non-transitory computer-readable medium that stores one or more instructions for wireless communication by a UE. The one or more instructions, when executed by one or more processors of the UE, may cause the UE to identify one or more quality metrics associated with one or more respective CCEs of a first set of candidate resources that partially overlaps with a second set of candidate resources, wherein the first set of candidate resources is associated with a first aggregation level and the second set of candidate resources is associated with a second aggregation level. The one or more instructions, when executed by one or more processors of the UE, may cause the UE to prune the second set of candidate resources based at least in part on a shaping pattern of the one or more quality metrics satisfying a quality tolerance threshold.

Some aspects described herein relate to a non-transitory computer-readable medium that stores one or more instructions for wireless communication. The one or more instructions, when executed by one or more processors of the UE, may cause the UE to identify a first set of candidate resources that fully overlaps with one or more second sets of candidate resources, wherein the first set of candidate resources is associated with a first aggregation level and the one or more second sets of candidate resources are associated with a second aggregation level, wherein the first aggregation level is greater than the second aggregation level. The one or more instructions, when executed by one or more processors of the UE, may cause the UE to perform, based at least in part on the first aggregation level being greater than the second aggregation level, a first decode operation on the first set of candidate resources before selectively performing one or more second decode operations on the one or more second sets of candidate resources.

Some aspects described herein relate to an apparatus for wireless communication. The apparatus may include means for identifying one or more quality metrics associated with one or more respective CCEs of a first set of candidate resources that partially overlaps with a second set of candidate resources, wherein the first set of candidate resources is associated with a first aggregation level and the second set of candidate resources is associated with a second aggregation level. The apparatus may include means for pruning the second set of candidate resources based at least in part on a shaping pattern of the one or more quality metrics satisfying a quality tolerance threshold.

Some aspects described herein relate to an apparatus for wireless communication. The apparatus may include means for identifying a first set of candidate resources that fully overlaps with one or more second sets of candidate resources, wherein the first set of candidate resources is associated with a first aggregation level and the one or more second sets of candidate resources are associated with a second aggregation level, wherein the first aggregation level is greater than the second aggregation level. The apparatus may include means for performing, based at least in part on the first aggregation level being greater than the second aggregation level, a first decode operation on the first set of candidate resources before selectively performing one or more second decode operations on the one or more second sets of candidate resources.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example associated with a histogram of mutual information (MI) bins, in accordance with the present disclosure.

FIG. 5 is a diagram illustrating an example associated with blind decoder candidates having partial resource overlap, in accordance with the present disclosure.

FIG. 6 is a diagram illustrating an example associated with an interleaver, in accordance with the present disclosure.

FIG. 7 is a diagram illustrating an example associated with handling partially overlapping candidate resources, in accordance with the present disclosure.

FIG. 8 is a diagram illustrating examples associated with shaping patterns of quality metrics, in accordance with the present disclosure.

FIG. 9 is a diagram illustrating an example associated with handling fully overlapping candidate resources, in accordance with the present disclosure.

FIG. 10 is a diagram illustrating an example associated with fully overlapping candidate resources, in accordance with the present disclosure.

FIG. 11 is a diagram illustrating a first example associated with overlapping candidate resources in search space 0, in accordance with the present disclosure.

FIG. 12 is a diagram illustrating a second example associated with overlapping candidate resources in search space 0, in accordance with the present disclosure.

FIG. 13 is a diagram illustrating an example process performed, for example, at a UE or an apparatus of a UE, in accordance with the present disclosure.

FIG. 14 is a diagram illustrating an example process performed, for example, at a UE or an apparatus of a UE, in accordance with the present disclosure.

FIG. 15 is a diagram of an example apparatus for wireless communication, in accordance with the present disclosure.

### DETAILED DESCRIPTION

Downlink control channel decoding is often based on blind decoding. Blind decoding involves monitoring every candidate time slot or subframe, even when there is no transmission. As a result, blind decoding can consume significant power. Blind decoding can also increase the end-to-end receive timeline because blind decoding is performed for the entire blind decoder candidate list. Early termination techniques can reduce the number of decoding attempts, thereby reducing power consumption and the end-to-end decoding timeline. Early termination allows a user equipment (UE) to prune blind decoding candidates before performing a full decode on those candidates.

In some cases, an overlapping blind decoder candidate can pass early termination even if that candidate should be pruned. The overlap introduces ambiguity that hinders the ability of the UE to determine which of the overlapping blind decoder candidates can be pruned. For example, a candidate that partially or fully overlaps with another candidate and should be pruned may satisfy a pruning threshold. By satisfying the pruning threshold, the candidate may avoid pruning due to the partial or full overlap with the other candidate. As a result, blind decoder candidates with partially or fully overlapping resources may reducing pruning efficiency, causing the UE to consume excessive power by blindly decoding those candidates that should be pruned.

Various aspects relate generally to handling of candidate resources. Some aspects more specifically relate to blind decoding candidates that partially or fully overlap. In some examples, a UE identifies quality metric(s) associated with control channel element(s) (CCE(s)) of a first set of candidate resources that partially overlaps with a second set of candidate resources. The first set of candidate resources and the second set of candidate resources are associated with respective aggregation levels (e.g., a first aggregation level and a second aggregation level). The UE may determine that the quality metric(s) satisfy a quality tolerance threshold, which may indicate that the first set of candidate resources carries a transmission at the first aggregation level. The UE may, based on the quality metric(s) satisfy a quality tolerance threshold, prune the second set of candidate resources.

In some examples, a UE identifies a first set of candidate resources that fully overlaps with one or more second sets of candidate resources. The first set of candidate resources and the one or more second sets of candidate resources are associated with respective aggregation levels (e.g., a first aggregation level and a second aggregation level). The first aggregation level may be greater than the second aggregation level. The UE may perform a first decode operation on the first set of candidate resources before selectively performing one or more second decode operations on the one or more second sets of candidate resources. For example, the UE may perform the first decode operation on the first set of candidate resources, and if the first decode operation is successful, then the UE may prune (e.g., refrain from performing) the one or more second decode operations on the one or more second sets of candidate resources. On the other hand, if the first decode operation is unsuccessful, then the UE may perform the one or more second decode operations on the one or more second sets of candidate resources.

Particular aspects of the subject matter described in this disclosure can be implemented to realize one or more of the following potential advantages. In some examples, by pruning the second set of candidate resources based at least in part on the shaping pattern satisfying the quality tolerance threshold, the described techniques can be used to reduce blind decoder power consumption, and improve the blind decoder timeline, in the presence of partially overlapped candidates. For example, pruning the second set of candidate resources may improve the pruning efficiency of partially overlapped candidates and result in a lower quantity of decoder operations performed by the UE.

In some examples, by performing the first decode operation on the first set of candidate resources before selectively performing the one or more second decode operations on the one or more second sets of candidate resources, the described techniques can be used to reduce blind decoder power consumption, and improve the blind decoder timeline, in the presence of fully overlapped candidates. For example, performing the first decode operation before selectively performing the one or more second decode operations may reduce the quantity of decode operations performed by the UE on fully overlapped candidates.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

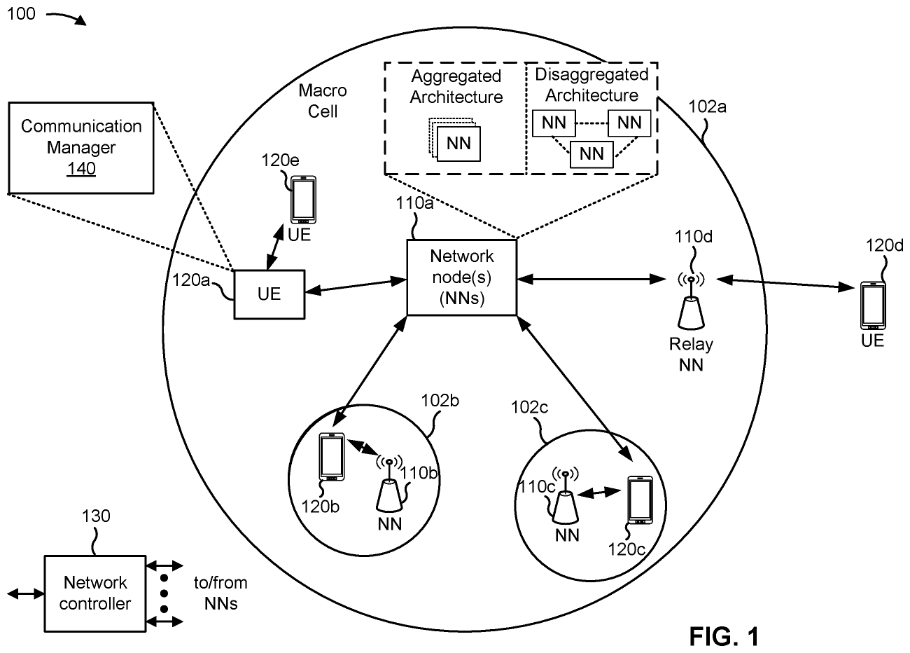

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may identify one or more quality metrics associated with one or more respective CCEs of a first set of candidate resources that partially overlaps with a second set of candidate resources, wherein the first set of candidate resources is associated with a first aggregation level and the second set of candidate resources is associated with a second aggregation level; and prune the second set of candidate resources based at least in part on a shaping pattern of the one or more quality metrics satisfying a quality tolerance threshold. Additionally, or alternatively, the communication manager 140 may perform one or more other operations described herein.

In some aspects, as described in more detail elsewhere herein, the communication manager 140 may identify a first set of candidate resources that fully overlaps with one or more second sets of candidate resources, wherein the first set of candidate resources is associated with a first aggregation level and the one or more second sets of candidate resources are associated with a second aggregation level, wherein the first aggregation level is greater than the second aggregation level; and perform, based at least in part on the first aggregation level being greater than the second aggregation level, a first decode operation on the first set of candidate resources before selectively performing one or more second decode operations on the one or more second sets of candidate resources. Additionally, or alternatively, the communication manager 140 may perform one or more other operations described herein.

As indicated above, FIG. 1 is provided as an example. Other examples may differ from what is described with regard to FIG. 1.

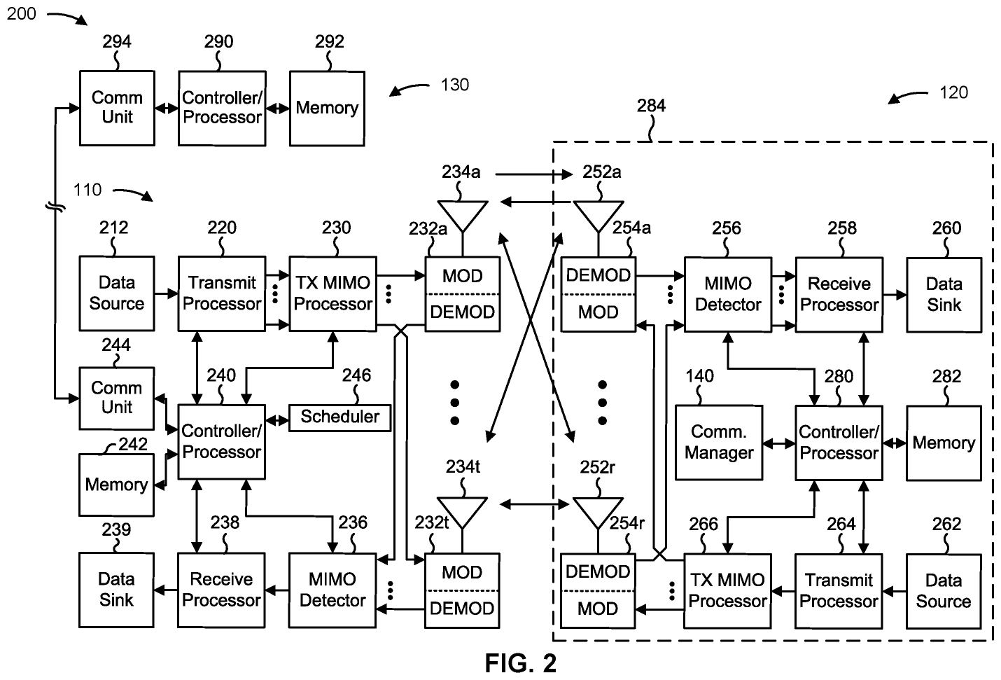

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

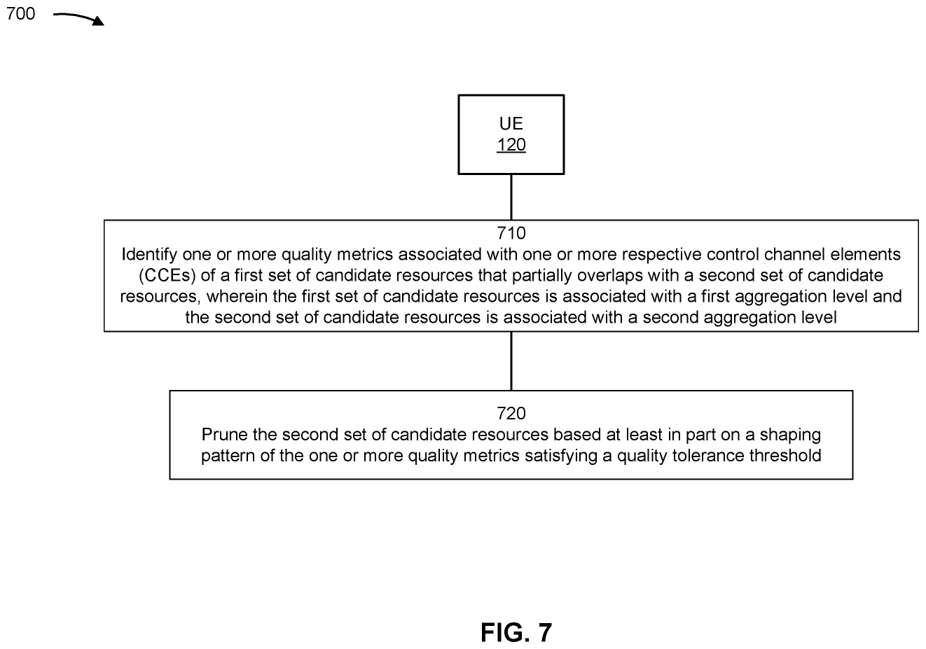

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-16).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-16).

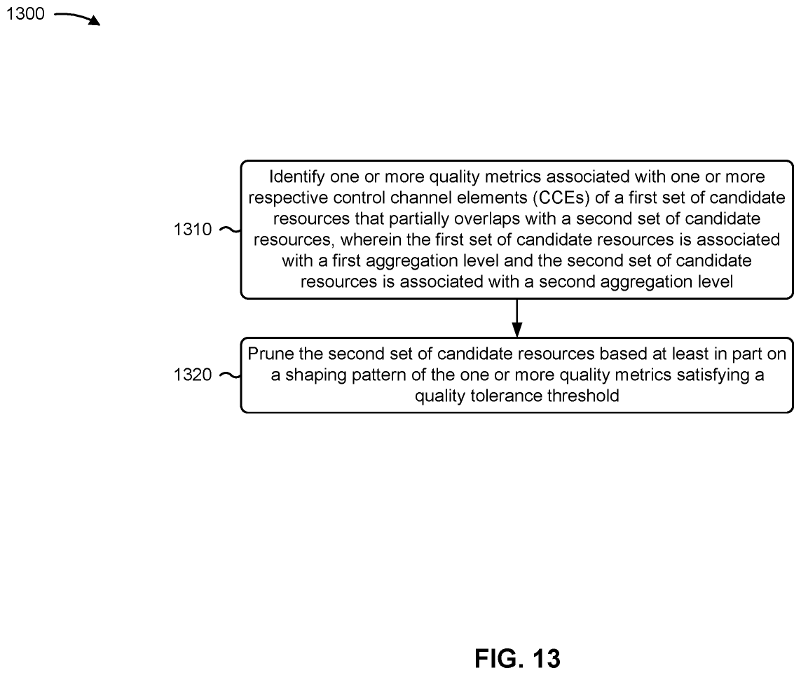

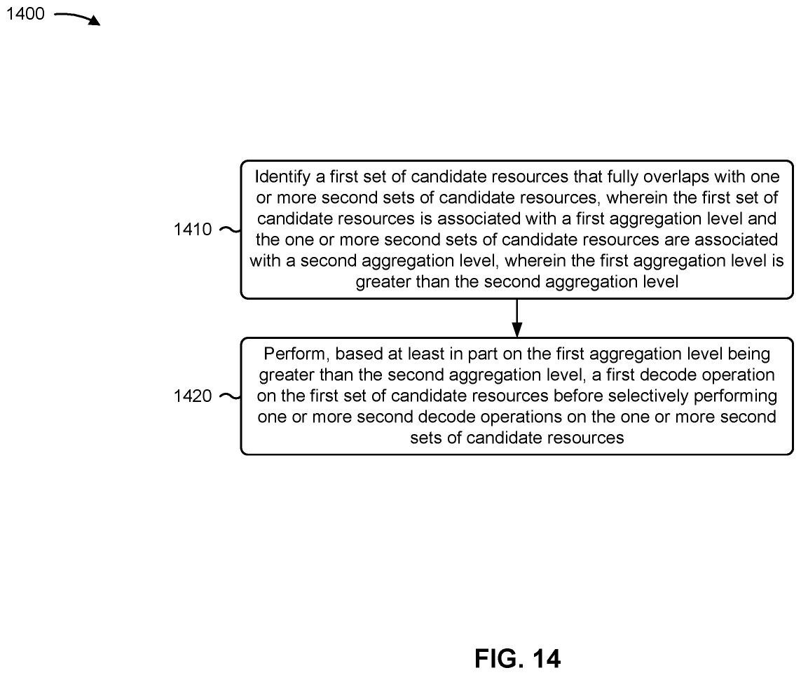

The controller/processor 240 of the network node 110, the controller/processor 280 of the UE 120, and/or any other component(s) of FIG. 2 may perform one or more techniques associated with handling of candidate resources, as described in more detail elsewhere herein. For example, the controller/processor 240 of the network node 110, the controller/processor 280 of the UE 120, and/or any other component(s) of FIG. 2 may perform or direct operations of, for example, process 1300 of FIG. 13, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, the UE 120 includes means for identifying one or more quality metrics associated with one or more respective CCEs of a first set of candidate resources that partially overlaps with a second set of candidate resources, wherein the first set of candidate resources is associated with a first aggregation level and the second set of candidate resources is associated with a second aggregation level; and/or means for pruning the second set of candidate resources based at least in part on a shaping pattern of the one or more quality metrics satisfying a quality tolerance threshold. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for identifying a first set of candidate resources that fully overlaps with one or more second sets of candidate resources, wherein the first set of candidate resources is associated with a first aggregation level and the one or more second sets of candidate resources are associated with a second aggregation level, wherein the first aggregation level is greater than the second aggregation level; and/or means for performing, based at least in part on the first aggregation level being greater than the second aggregation level, a first decode operation on the first set of candidate resources before selectively performing one or more second decode operations on the one or more second sets of candidate resources. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

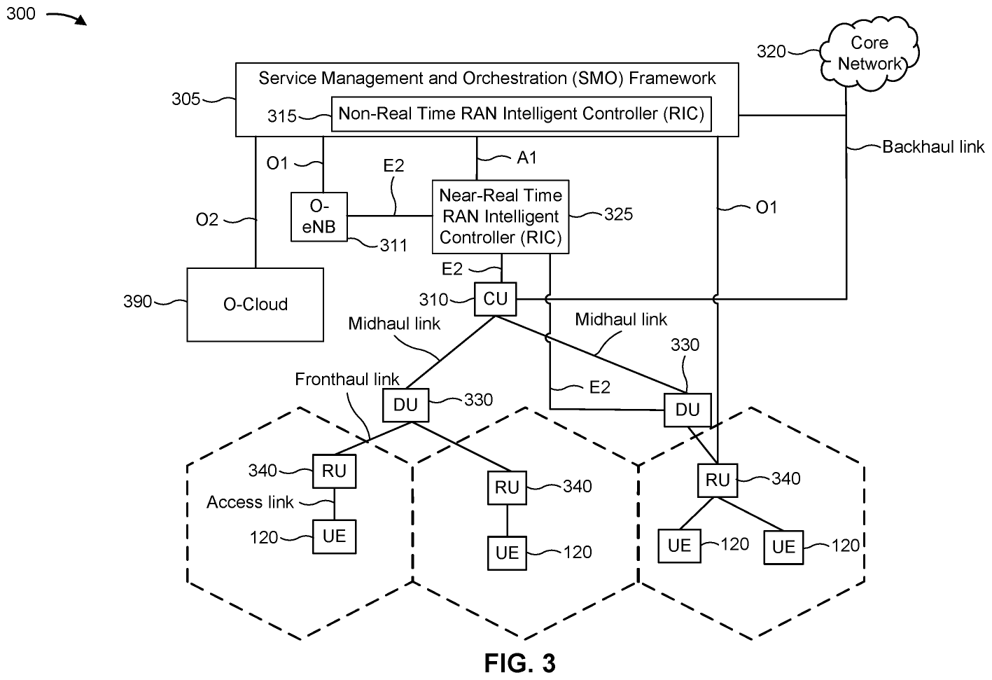

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 May communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

In many wireless specifications (e.g., 3G, 4G, 5G NR, and cellular V2X (CV2X), among others), downlink control channel (e.g., physical downlink control channel (PDCCH)) decoding is blind decoder based. Blind decoding can involve monitoring every candidate time slot or subframe (e.g., constant polling). Generally, blind decoders consume significant power, even when there is no traffic, and are major factors in the end-to-end receive timeline because the UE always performs blind decoding of the entire blind decoder candidate list.

PDCCH decoder power consumption and dimensioning are dictated by the peak number of blind decode candidates per time slot (rather than the peak of the quantity of actually transmitted control channel (CCH) packets). Per-CCH candidate early termination (or pruning) techniques can reduce the number of decoding attempts, thereby reducing power consumption and the end-to-end decoding timeline.

Generally, per-CCH candidate pruning techniques involve producing a per-candidate quality metric and comparing the per-candidate quality metric to a threshold for pruning. Examples of per-candidate quality metrics include DMRS signal-to-noise-ratio (SNR), log-likelihood ratio (LLR)-based metrics, and mutual information (MI). In some examples, a UE may determine whether a candidate is carrying information based on the SNR of the DMRS in a candidate.

In some examples, a UE may determine that the probability that a candidate is carrying information is low based on the LLR of the candidate. LLR is defined as

$$L L R = log ( \frac{p}{1 - p} ) ,$$

where p is the probability of success (or bit error rate (BER)). The as following relationship enables transformation from LLR to p:

$${P}_{e} = \frac{1}{1 + {e}^{- \vert LLR \vert}} .$$

In some examples, a UE may determine whether to prune a candidate based on the MI (e.g., channel capacity) of the candidate. For instance, if the candidate downlink control information (DCI) length is 64 bits, then the UE may calculate the MI to determine a quantity of bits that can be carried on the channel, and if the quantity is less than 64 bits, then the UE may prune that candidate. MI reflects the per-bit information amount, which can be conveyed using a certain probability. In some examples, MI=1−[−Pₑ·log₂(Pₑ)−(1−Pₑ)·log₂(1−Pₑ)]. The number of information bits, which can be conveyed through a given channel, is the sum of the per-bit MI of transmitted coded bits (N), assuming an ideal channel coding: MI=Σᵢ₌₀^{N-1}(1−[−Pₑ_{ᵢ}·log₂(Pₑ_{ᵢ})−(1−Pₑ_{ᵢ})·log₂(1−Pₑ_{ᵢ})]).

Thus, MI-based pruning involves calculating the bottom line mutual information for a given CCH candidate just before the decoder operation, and the threshold used for pruning may be the DCI payload size. This may optimize pruning and be agnostic to the quantity of receive antennas, aggregation level, SNR, or the like.

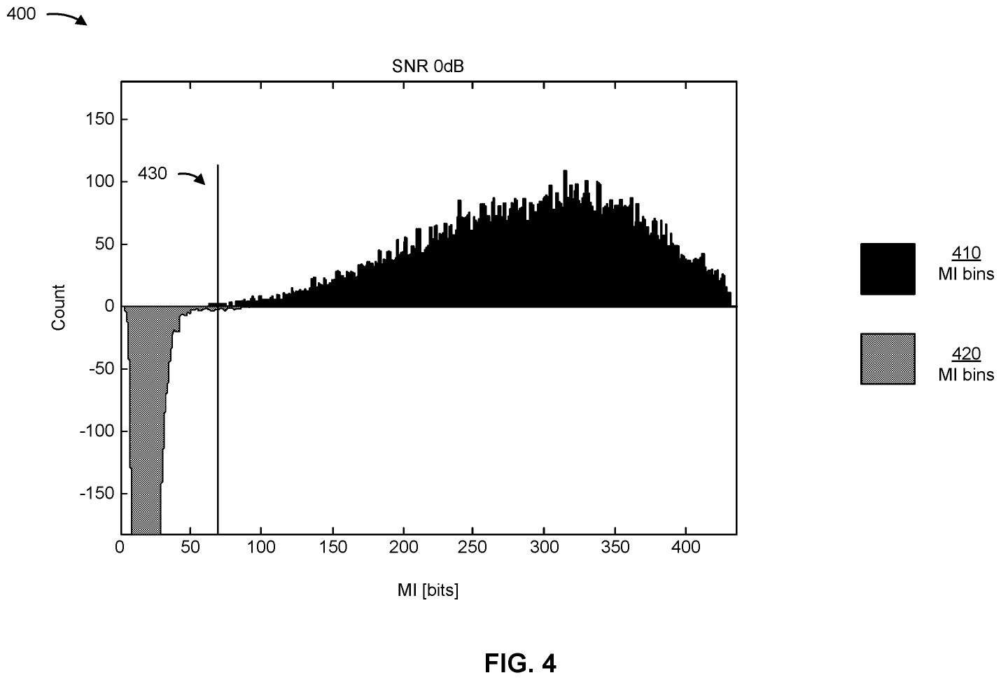

FIG. 4 is a diagram illustrating an example 400 associated with a histogram of MI that can be applied to an MI-based candidate pruning flow, in accordance with the present disclosure.

The histogram contains MI bins 410 and MI bins 420. The MI bins 410 are associated with good cyclic redundancy check (CRC) counts per MI results, and the MI bins 420 are associated with poor CRC counts per MI results. The MI may be calculated using candidate LLRs. In some examples, the MI bins 420 may be associated with poor CRC counts due to non-allocated candidates and allocated candidates that failed decoding. The count for the MI bins 420 may be negative to achieve separation.

The MI may be compared with a pruning threshold 430 for pruning. The pruning threshold 430 may be determined based on a candidate payload size K. In some examples, the pruning threshold 430 (TH) may be applied based on

$$TH = \frac{{K}_{Information}}{E - {N}_{Repetion} + {N}_{Puncture} + {N}_{Shortening}} = \frac{K}{N} .$$

In some examples, the calculation may be simplified by skipping division by N. Thus, the pruning threshold 430 may be equal to the payload size K. As shown, the pruning threshold 430 is approximately equal to the payload size (e.g., 69 bits). Almost all candidates with poor CRC may be pruned based on the pruning threshold 430 without introducing significant quantities of missed detections.

As indicated above, FIG. 4 is provided as an example. Other examples may differ from what is described with respect to FIG. 4.

Transmission of blind decoder candidates having resource overlap may result in overlapped candidates passing early termination, thereby reducing pruning efficiency. For example, the resource overlap may introduce an ambiguity that hinders determining which blind decoder candidate can be pruned. For example, in the case of different candidates with partial resource overlap, those candidates may satisfy a pruning threshold, thus reducing pruning efficiency. Different candidates with full resource overlap may prevent the UE from resolving the ambiguity of which blind decoder candidate is to be pruned at an early decoding stage. As a result, blind decoder candidates with partially or fully overlapping resources may cause the UE to consume excessive power.

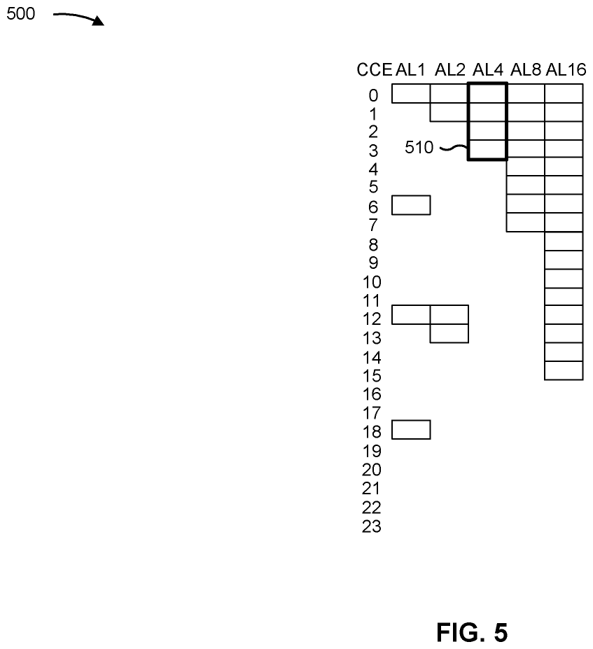

FIG. 5 is a diagram illustrating an example 500 associated with blind decoder candidates having partial resource overlap, in accordance with the present disclosure.

Example 500 shows a control resource set (CORESET) with 24 CCEs. Example 500 includes four candidates at aggregation level 1 (AL1), two candidates at aggregation level 2 (AL2), one candidate 510 at aggregation level 4 (AL4), one candidate at aggregation level 8 (AL8), and one candidate at aggregation level 16 (AL16). Upon transmission of the candidate 510 (starting at CCE0), the overlapping candidates at AL1 and AL2 (starting at CCE0) would pass the pruning threshold, and the overlapping candidates at AL8 and AL16 (starting at CCE0) may pass the pruning threshold. A UE may perform decoding (e.g., polar decoding) for each aggregation level because each aggregation level generally has unique parameters (e.g., encoding, rate matching, or the like). Hence, up to five candidates would pass pruning, creating poor pruning efficiency.

As indicated above, FIG. 5 is provided as an example. Other examples may differ from what is described with respect to FIG. 5.

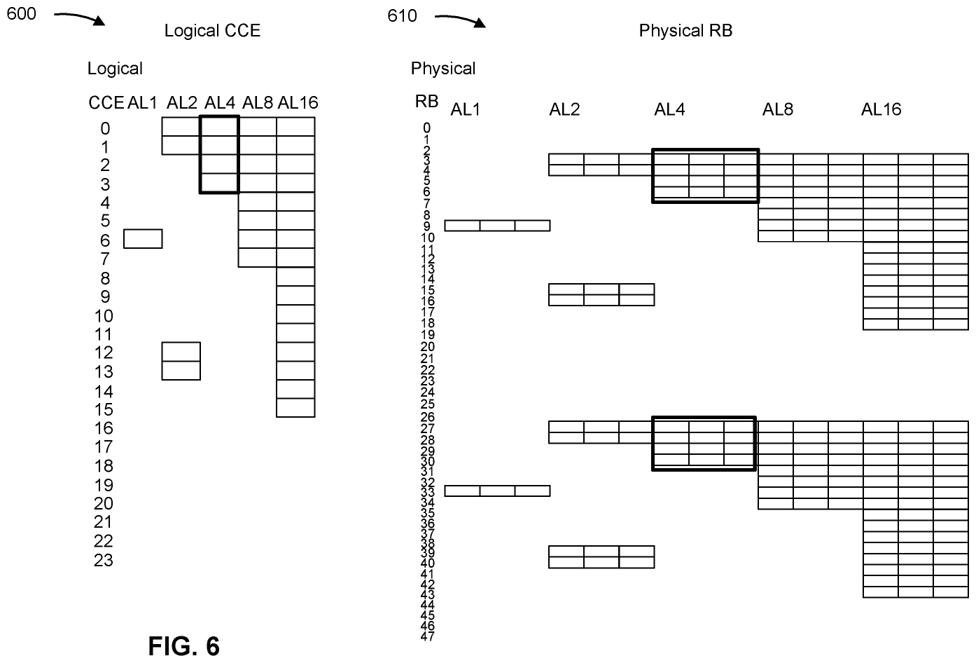

FIG. 6 is a diagram illustrating an examples 600 and 610 associated with an interleaver, in accordance with the present disclosure.

5G NR PDCCH candidates may be configured for PDCCH interleaving, which may involve scattering logical candidates upon mapping to physical resources. Example 600 shows a plot, which includes 24 CCEs, of the location of logical PDCCH candidates. Example 610 shows a plot of the physical mapping of the logical PDCCH candidates to physical resource blocks (RBs). In example 610, the quantity of symbols is three, the resource element group (REG) bundle size is three, the quantity of interleaver rows R is two, and the shift value is three. An interleaving operation on the candidates splits the candidate logical units (e.g., CCEs) into fragments (e.g., RB bundles) of the same overlapping pattern. Thus, the candidate overlapping pattern—and the ambiguity issues described above—are agnostic to interleaving.

As indicated above, FIG. 6 is provided as an example. Other examples may differ from what is described with respect to FIG. 6.

FIG. 7 is a diagram illustrating an example 700 associated with handling partially overlapping candidate resources, in accordance with the present disclosure.

As shown by reference number 710, a UE 120 may identify one or more quality metrics associated with one or more respective control channel elements (CCEs) of a first set of candidate resources that partially overlaps with a second set of candidate resources. For example, the one or more quality metrics (e.g., MI per aggregation unit) may be one or more per-CCE quality metrics. For example, the UE 120 may calculate at least two per-CCE quality metrics for AL2, at least four per-CCE quality metrics for AL4, or the like.

In some aspects, the one or more respective CCEs include one or more interleaved CCEs that are mapped to one or more physical RBs (PRBs). In some aspects, the PRBs may be discontinuous. For example, the quantity of interleaver rows may be greater than one. The one or more respective CCEs including the one or more interleaved CCEs may enable the UE 120 to apply implementations described herein to interleaver scenarios.

The first set of candidate resources may be associated with a first aggregation level, and the second set of candidate resources may be associated with a second aggregation level. For example, the first set of candidate resources may be at AL4, and the second set of candidate resources may be at AL8. In some aspects, the first set of candidate resources includes one or more PDCCH candidate resources, and/or the second set of candidate resources includes one or more PDCCH candidate resources.

As shown by reference number 720, the UE 120 may prune the second set of candidate resources based at least in part on a shaping pattern of the one or more quality metrics satisfying a quality tolerance threshold. For example, the shaping pattern may be a pattern of the per-CCE quality metrics over the corresponding CCEs. The one or more quality metrics satisfying the quality tolerance threshold may indicate that the first set of candidate resources (rather than the second set of candidate resources) is to be decoded.

For example, in the case where the first set of candidate resources is at AL4, and the second set of candidate resources is at AL8, the shaping pattern of the one or more quality metrics may satisfy the quality tolerance threshold for only four CCEs. Thus, the UE 120 may prune the second set of candidate resources because the quality metrics do not satisfy the quality tolerance threshold for eight CCEs.

Pruning the second set of candidate resources based at least in part on the shaping pattern satisfying the quality tolerance threshold may enable the UE 120 to reduce CCH blind decoder power consumption, and improve the CCH blind decoder timeline, in the presence of partially overlapped candidates. The expected power gain (e.g., savings) may depend on the network configuration (e.g., the expected power gain may increase with the configured aggregation level). The UE 120 may apply the candidate ambiguity resolution scheme of example 700 for partially overlapped candidates, which may improve the pruning efficiency of partially overlapped candidates and result in a lower quantity of decoder operations performed by the UE 120.

As indicated above, FIG. 7 is provided as an example. Other examples may differ from what is described with respect to FIG. 7.

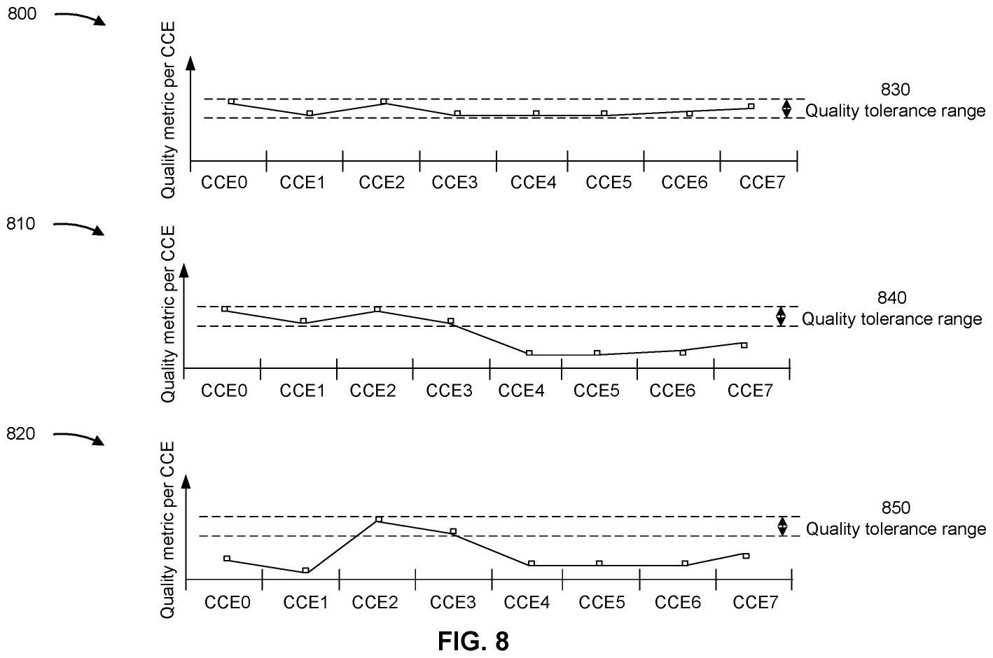

FIG. 8 is a diagram illustrating examples 800, 810, and 820 associated with shaping patterns of quality metrics, in accordance with the present disclosure.

Example 800 is a plot that depicts a first shaping pattern of per-CCE quality metrics. As shown, all eight quality metrics satisfy a quality tolerance range 830. In some aspects, the quality tolerance range 830 may be associated with the quality tolerance threshold. For example, the quality tolerance range 830 may include a first quality tolerance threshold (e.g., an upper bound of the quality tolerance range 830) and a second quality tolerance threshold (e.g., a lower bound of the quality tolerance range 830). The quality metrics may satisfy the quality tolerance range 830 in that the quality metrics are within the quality tolerance range 830 (e.g., between the first quality tolerance threshold and the second quality tolerance threshold).

In some aspects, the quality tolerance threshold (e.g., the upper or lower bound of the quality tolerance range 840) may be based at least in part on the first aggregation level. For example, the quality tolerance threshold (and/or the quality tolerance range 830) may have different value(s) for AL1 shaping-pattern-based pruning, AL2 shaping-pattern-based pruning, AL4 shaping-pattern-based pruning, AL8 shaping-pattern-based pruning, AL16 shaping-pattern-based pruning, or the like. Thus, the quality tolerance threshold (and/or the quality tolerance range 830) may be defined per aggregation level.

The UE 120 may examine whether the per-CCE metric pattern matches an expected aggregation level. In some aspects, a quantity of the one or more quality metrics satisfying the quality tolerance threshold (e.g., the quality tolerance range 830) may be associated with the first aggregation level. For example, the quantity of quality metrics satisfying the quality tolerance threshold is eight. Thus, the shaping pattern is compatible with AL8 and may pass AL8 shaping-pattern-based pruning.

Example 810 is a plot that depicts a second shaping pattern of per-CCE quality metrics. As shown, only four out of eight quality metrics satisfy a quality tolerance range 840. In some aspects, the quality tolerance range 840 may be associated with the quality tolerance threshold. For example, the quality tolerance range 840 may include a first quality tolerance threshold (e.g., an upper bound of the quality tolerance range 840) and a second quality tolerance threshold (e.g., a lower bound of the quality tolerance range 840). The four quality metrics may satisfy the quality tolerance range 840 in that the four quality metrics are within the quality tolerance range 840 (e.g., between the first quality tolerance threshold and the second quality tolerance threshold).

In some aspects, the quality tolerance threshold (e.g., the upper or lower bound of the quality tolerance range 840) may be based at least in part on the first aggregation level. For example, the quality tolerance threshold (and/or the quality tolerance range 840) may have different value(s) for AL1 shaping-pattern-based pruning, AL2 shaping-pattern-based pruning, AL4 shaping-pattern-based pruning, AL8 shaping-pattern-based pruning, AL16 shaping-pattern-based pruning, or the like. Thus, the quality tolerance threshold (and/or the quality tolerance range 840) may be defined per aggregation level.

The UE 120 may examine whether the per-CCE metric pattern matches an expected aggregation level. In some aspects, a quantity of the one or more quality metrics satisfying the quality tolerance threshold (e.g., the quality tolerance range 840) may be associated with the first aggregation level. For example, the quantity of quality metrics satisfying the quality tolerance threshold is four. Thus, the shaping pattern is compatible with AL4 and may pass AL4 shaping-pattern-based pruning.

The UE 120 may prune partially overlapping candidates according to the shaping pattern of the quality metrics. For example, whereas the first shaping pattern (example 800) may pass AL8-shape-based-pruning, the second shaping pattern (example 810) may be pruned. The UE 120 may prune the second shaping pattern in response to determining that the second shaping pattern corresponds to an AL4 candidate (or two AL2 candidates, or four AL1 candidates) rather than an AL8 candidate. For example, the UE 120 may correlate the second shaping pattern with aggregation levels below AL8 based at least in part on a sharp metric change at lower aggregation level boundaries (e.g., the boundary between CCE3 and CCE4).

Example 820 is a plot that depicts a third shaping pattern of per-CCE quality metrics. As shown, only two out of eight quality metrics satisfy a quality tolerance range 850. In some aspects, the quality tolerance range 850 may be associated with the quality tolerance threshold. For example, the quality tolerance range 850 may include a first quality tolerance threshold (e.g., an upper bound of the quality tolerance range 850) and a second quality tolerance threshold (e.g., a lower bound of the quality tolerance range 850). The two quality metrics may satisfy the quality tolerance range 850 in that the two quality metrics are within the quality tolerance range 850 (e.g., between the first quality tolerance threshold and the second quality tolerance threshold).

In some aspects, the quality tolerance threshold (e.g., the upper or lower bound of the quality tolerance range 850) may be based at least in part on the first aggregation level. For example, the quality tolerance threshold (and/or the quality tolerance range 850) may have different value(s) for AL1 shaping-pattern-based pruning, AL2 shaping-pattern-based pruning, AL4 shaping-pattern-based pruning, AL8 shaping-pattern-based pruning, AL16 shaping-pattern-based pruning, or the like. Thus, the quality tolerance threshold (and/or the quality tolerance range 850) may be defined per aggregation level.

The UE 120 may examine whether the per-CCE metric pattern matches an expected aggregation level. In some aspects, a quantity of the one or more quality metrics satisfying the quality tolerance threshold (e.g., the quality tolerance range 850) may be associated with the first aggregation level. For example, the quantity of quality metrics satisfying the quality tolerance threshold is two. Thus, the shaping pattern is compatible with AL2 and may pass AL2 shaping-pattern-based pruning.

The UE 120 may prune partially overlapping candidates according to the shaping pattern of the quality metrics. For example, whereas the first shaping pattern (example 800) may pass AL8-shape-based-pruning, the third shaping pattern (example 820) may be pruned. The UE 120 may prune the third shaping pattern in response to determining that the third shaping pattern corresponds to an AL2 candidate (or two AL1 candidates) rather than an AL8 candidate. For example, the UE 120 may correlate the third shaping pattern with aggregation levels below AL8 based at least in part on a sharp metric change at lower aggregation level boundaries (e.g., the boundary between CCE1 and CCE2 and the boundary between CCE3 and CCE4).

The quality tolerance threshold being based at least in part on the first aggregation level may enable the quality tolerance threshold to be adjusted according to the relevant aggregation level, thereby improving the capability of the UE 120 to prune candidates based on shaping pattern. The quantity of the one or more quality metrics satisfying the quality tolerance threshold being associated with the first aggregation level may help to ensure that the UE 120 accurately identifies which aggregation levels to prune.

As indicated above, FIG. 8 is provided as an example. Other examples may differ from what is described with respect to FIG. 8.

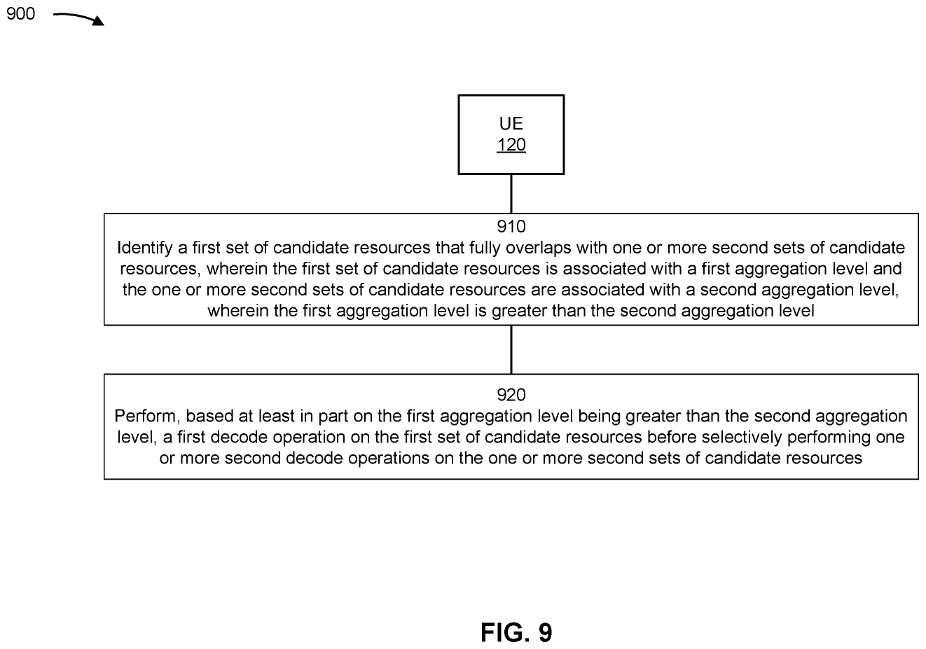

FIG. 9 is a diagram illustrating an example 900 associated with handling fully overlapping candidate resources, in accordance with the present disclosure.

As shown by reference number 910, the UE 120 may identify a first set of candidate resources that fully overlaps with one or more second sets of candidate resources. In some aspects, the first set of candidate resources includes one or more PDCCH candidate resources, and/or the second set of candidate resources includes one or more PDCCH candidate resources. The first set of candidate resources may be associated with a first aggregation level, and the one or more second sets of candidate resources may be associated with a second aggregation level. In some aspects, the first aggregation level may be greater than the second aggregation level. For example, the first aggregation level may be AL16 and the second aggregation level may be AL8. For example, the second sets of candidate resources may be two sets of candidate resources at AL8 that fully overlap with the first set of candidate resources at AL16.

As shown by reference number 920, the UE 120 may perform, based at least in part on the first aggregation level being greater than the second aggregation level, a first decode operation (e.g., a first polar decode operation) on the first set of candidate resources before selectively performing one or more second decode operations (e.g., one or more second polar decode operations) on the one or more second sets of candidate resources. For example, the UE 120 may perform the first decode operation on the first set of candidate resources. If the first decode operation is successful, then the UE 120 may prune (e.g., refrain from performing) the one or more second decode operations on the one or more second sets of candidate resources. If the first decode operation is unsuccessful, then the UE 120 may perform the one or more second decode operations on the one or more second sets of candidate resources.

Performing the first decode operation on the first set of candidate resources before selectively performing the one or more second decode operations on the one or more second sets of candidate resources may enable the UE 120 to reduce CCH blind decoder power consumption, and improve the CCH blind decoder timeline, in the presence of fully overlapped candidates. The expected power gain may depend on the network configuration (e.g., the expected power gain may increase with the configured aggregation level). The UE 120 may apply the candidate ambiguity resolution scheme of example 900 for fully overlapped candidates, which may improve the pruning efficiency of fully overlapped candidates and result in a lower quantity of decoder operations performed by the UE 120.

As indicated above, FIG. 9 is provided as an example. Other examples may differ from what is described with respect to FIG. 9.

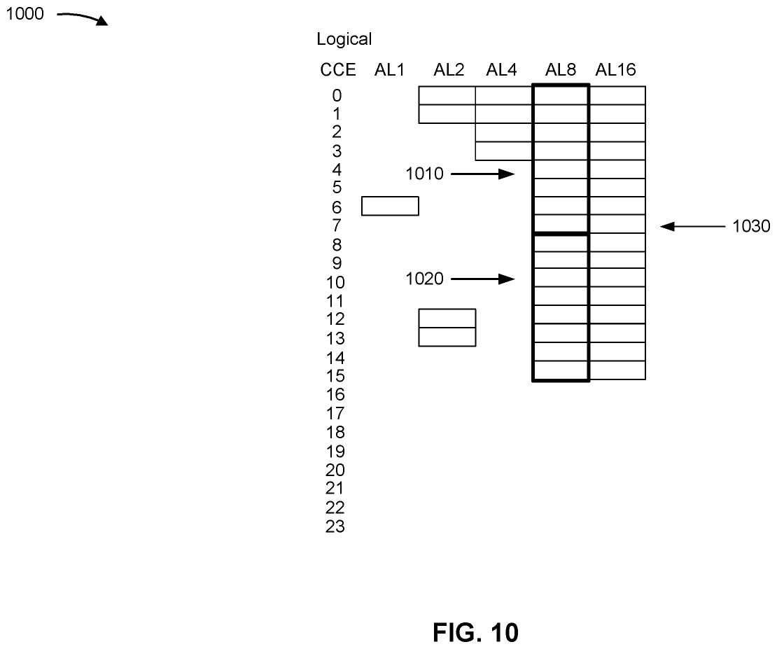

FIG. 10 is a diagram illustrating an example 1000 associated with fully overlapping candidate resources, in accordance with the present disclosure.

Example 1000 includes two AL8 candidates 1010 and 1020 that fully overlap with an AL16 candidate 1030. As explained above in connection with FIG. 9, the UE 120 may sort the AL8 candidates 1010 and 1020 and AL16 candidate 1030 from highest aggregation level to lowest and decode in that order. For example, the UE 120 May start with the AL16 candidate 1030, and, upon successfully decoding the AL16 candidate 1030, prune all nested candidates (e.g., AL8 candidates 1010 and 1020) accordingly. As a result, the UE 120 may attempt to decode the candidate associated with the biggest aggregation level before potentially decoding any candidates associated with smaller aggregation levels, which may minimize the quantity of decode operations. For example, the (single) AL16 candidate 1030 at may involve only one decode attempt, whereas the (two) AL8 candidates 1010 and 1020 may involve two decode attempts (e.g., one decode attempt for AL8 candidate 1010 and one decode attempt for AL8 candidate 1020). Thus, the UE 120 may attempt to decode the AL16 candidate 1030 before potentially performing two additional decode attempts for AL8 candidates 1010 and 1020.

As indicated above, FIG. 10 is provided as an example. Other examples may differ from what is described with respect to FIG. 10.

In some examples, aspects of handling partially overlapping resources and fully overlapping resources may be implemented together. For example, the UE 120 may perform one or more operations described above in connection with FIG. 7 and then perform one or more operations described above in connection with FIG. 9, perform one or more operations described above in connection with FIG. 9 and then perform one or more operations described above in connection with FIG. 7, and/or perform one or more operations described above in connection with FIG. 7 and perform one or more operations described above in connection with FIG. 9 simultaneously.

In some examples, in a first step, the UE 120 may perform per-candidate pruning. For example, the UE 120 may prune all candidates having quality metrics (e.g., per-candidate quality metrics) that do not satisfy a pruning quality metric threshold. The quality metric threshold may be based on a variety of heuristics, such as the DMRS SNR, LLR, or MI of the candidates, among other examples. The first step may enable the UE 120 to prune non-overlapping candidates.

In a second step, the UE 120 may perform pattern-based pruning based on per-CCE metrics, as described above in connection with FIGS. 7 and 8. For example, the UE 120 may apply the pattern-based pruning to candidates (e.g., partially or fully overlapping candidates) that passed the pruning quality metric threshold in the first step.

In a third step, the UE 120 may perform sorted CRC-based pruning, as described above in connection with FIGS. 9 and 10. For example, the UE 120 may apply the sorted CRC-based pruning to the candidates that pass the pattern-based pruning in the second step. For instance, the candidates may be fully overlapping candidates having ambiguity that was not resolved by the pattern-based pruning. For example, the candidates may include two AL8 candidates and one AL16 candidates that fully overlap and remain ambiguous after the UE 120 performs pattern-based pruning based on per-CCE metrics on the associated transmission.

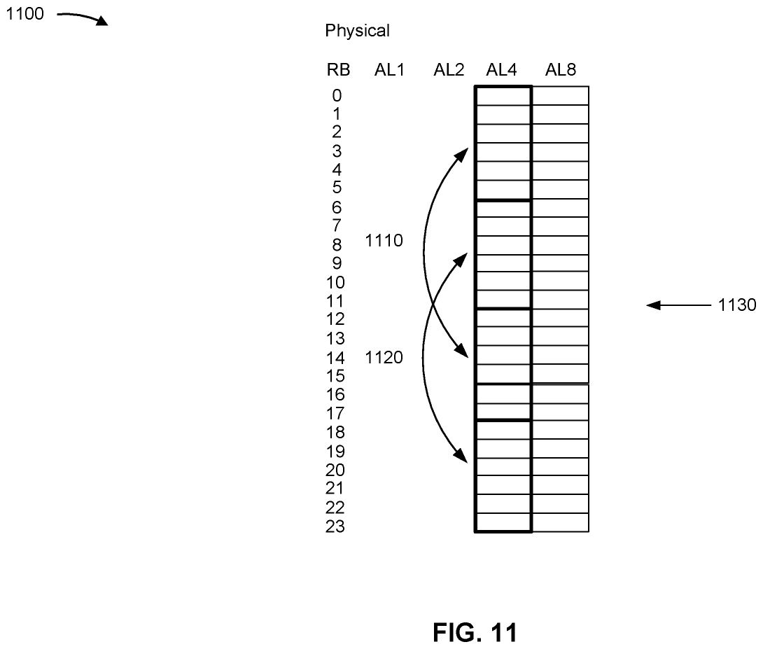

FIG. 11 is a diagram illustrating a first example 1100 associated with overlapping candidate resources in search space 0, in accordance with the present disclosure.

Search space 0 may be associated with high aggregation levels and low quantities of CCEs. Example 1100 involves 24 RBs, a symbol number of two, and eight CCEs. As shown, example 1100 includes three candidates: AL4 candidate 1110, AL4 candidate 1120, and AL8 candidate 1130. AL4 candidates 1110 and 1120 overlap with AL8 candidate 1130.

In a case involving an AL4 transmission (e.g., at AL4 candidate 1110), the UE 120 may prune the AL8 candidate 1130 based on a shaping pattern of the AL4 transmission. The UE 120 may prune the other AL4 candidate (e.g., AL4 candidate 1120) using MI, for example.

In a case involving an AL8 transmission, the UE 120 may check the CRC of the AL8 transmission. Upon successfully decoding the AL8 transmission in the AL8 candidate 1130, the UE 120 may prune the AL4 candidates 1110 and 1120.

Thus, the UE 120 may perform one polar operation per three candidates when DCI is transmitted, which may improve the gain. If there is no transmission, then the MI may prune AL4 candidate 1110, AL4 candidate 1120, and AL8 candidate 1130.

As indicated above, FIG. 11 is provided as an example. Other examples may differ from what is described with respect to FIG. 11.

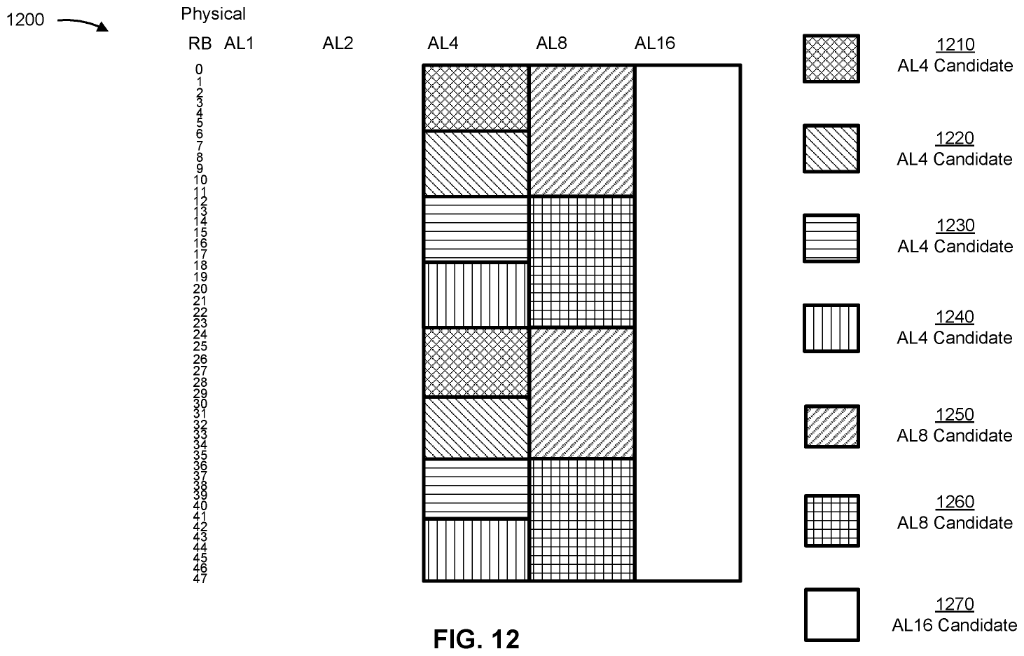

FIG. 12 is a diagram illustrating a second example 1200 associated with overlapping candidate resources in search space 0, in accordance with the present disclosure.

Example 1200 involves 48 RBs, a symbol number of two, and 16 CCEs. As shown, example 1200 includes seven overlapping, interleaved candidates: AL4 candidate 1210, AL4 candidate 1220, AL4 candidate 1230, AL4 candidate 1240, AL8 candidate 1250, AL8 candidate 1260, and AL16 candidate 1270.

In a case involving an AL4 transmission (e.g., at AL4 candidate 1210), the UE 120 may prune the overlapping AL8 candidate 1250 and the AL16 candidate 1270 based on a shaping pattern of the AL4 transmission. The UE 120 may prune the other AL4 candidates (e.g., AL4 candidate 1220-1240) and non-overlapping AL8 candidate (e.g., AL8 candidate 1260) using MI, for example.

In a case involving an AL8 transmission (e.g., at AL8 candidate 1250), the UE 120 may prune the overlapping AL16 candidate 1270 based on a shaping pattern of the AL8 transmission. The UE 120 may prune the other AL4 candidates (e.g., AL4 candidates 1220-1240) and non-overlapping AL8 candidate (e.g., AL8 candidate 1260) using MI, for example.

In a case involving an AL16 transmission (e.g., at AL16 candidate 1270), the UE 120 may prune all other candidates 1210-1260 by resolving ambiguity using the AL16 CRC.

Thus, the UE 120 may perform one polar operation per seven candidates when DCI is transmitted, which may improve the gain. If there is no transmission, then the MI may prune candidates 1210-1270.

As indicated above, FIG. 12 is provided as an example. Other examples may differ from what is described with respect to FIG. 12.

FIG. 13 is a diagram illustrating an example process 1300 performed, for example, at a UE or an apparatus of a UE, in accordance with the present disclosure. Example process 1300 is an example where the apparatus or the UE (e.g., UE 120) performs operations associated with handling of candidate resources.

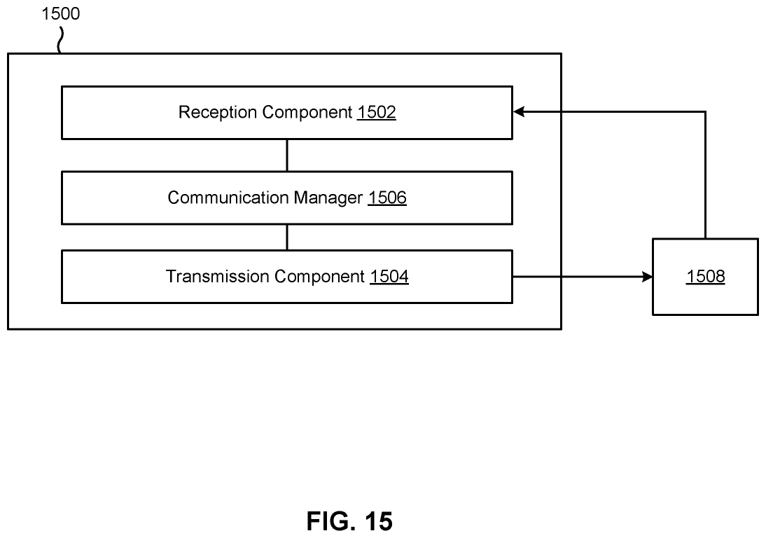

As shown in FIG. 13, in some aspects, process 1300 may include identifying one or more quality metrics associated with one or more respective CCEs of a first set of candidate resources that partially overlaps with a second set of candidate resources, wherein the first set of candidate resources is associated with a first aggregation level and the second set of candidate resources is associated with a second aggregation level (block 1310). For example, the UE (e.g., using communication manager 1506, depicted in FIG. 15) may identify one or more quality metrics associated with one or more respective CCEs of a first set of candidate resources that partially overlaps with a second set of candidate resources, wherein the first set of candidate resources is associated with a first aggregation level and the second set of candidate resources is associated with a second aggregation level, as described above.

As further shown in FIG. 13, in some aspects, process 1300 may include pruning the second set of candidate resources based at least in part on a shaping pattern of the one or more quality metrics satisfying a quality tolerance threshold (block 1320). For example, the UE (e.g., using communication manager 1506, depicted in FIG. 15) may prune the second set of candidate resources based at least in part on a shaping pattern of the one or more quality metrics satisfying a quality tolerance threshold, as described above.

Process 1300 may include additional aspects, such as any single aspect or any combination of aspects described below and/or in connection with one or more other processes described elsewhere herein.

In a first aspect, the quality tolerance threshold is associated with a quality tolerance range, and the shaping pattern of the one or more quality metrics satisfying the quality tolerance threshold includes the one or more quality metrics being within the quality tolerance range.

In a second aspect, alone or in combination with the first aspect, the quality tolerance threshold is based at least in part on the first aggregation level.

In a third aspect, alone or in combination with one or more of the first and second aspects, a quantity of the one or more quality metrics satisfying the quality tolerance threshold is associated with the first aggregation level.

In a fourth aspect, alone or in combination with one or more of the first through third aspects, the first set of candidate resources fully overlaps with one or more third sets of candidate resources associated with a third aggregation level.

In a fifth aspect, alone or in combination with one or more of the first through fourth aspects, the first aggregation level is greater than the third aggregation level, and process 1300 includes performing, based at least in part on the first aggregation level being greater than the third aggregation level, a first decode operation on the first set of candidate resources before selectively performing a second decode operation on the one or more third sets of candidate resources.

In a sixth aspect, alone or in combination with one or more of the first through fifth aspects, the one or more respective CCEs include one or more interleaved CCEs that are mapped to one or more physical resource blocks.

In a seventh aspect, alone or in combination with one or more of the first through sixth aspects, the one or more physical resource blocks are discontinuous.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a UE or an apparatus of a UE, in accordance with the present disclosure. Example process 1400 is an example where the apparatus or the UE (e.g., UE 120) performs operations associated with handling of candidate resources.

As shown in FIG. 14, in some aspects, process 1400 may include identifying a first set of candidate resources that fully overlaps with one or more second sets of candidate resources, wherein the first set of candidate resources is associated with a first aggregation level and the one or more second sets of candidate resources are associated with a second aggregation level, wherein the first aggregation level is greater than the second aggregation level (block 1410). For example, the UE (e.g., using communication manager 1506, depicted in FIG. 15) may identify a first set of candidate resources that fully overlaps with one or more second sets of candidate resources, wherein the first set of candidate resources is associated with a first aggregation level and the one or more second sets of candidate resources are associated with a second aggregation level, wherein the first aggregation level is greater than the second aggregation level, as described above.

As further shown in FIG. 14, in some aspects, process 1400 may include performing, based at least in part on the first aggregation level being greater than the second aggregation level, a first decode operation on the first set of candidate resources before selectively performing one or more second decode operations on the one or more second sets of candidate resources (block 1420). For example, the UE (e.g., using communication manager 1506, depicted in FIG. 15) may perform, based at least in part on the first aggregation level being greater than the second aggregation level, a first decode operation on the first set of candidate resources before selectively performing one or more second decode operations on the one or more second sets of candidate resources, as described above.

Process 1400 may include additional aspects, such as any single aspect or any combination of aspects described below and/or in connection with one or more other processes described elsewhere herein.

In a first aspect, the first set of candidate resources partially overlaps with a third set of candidate resources, the third set of candidate resources is associated with a third aggregation level, and process 1400 includes identifying one or more quality metrics associated with one or more respective CCEs of the first set of candidate resources, and pruning the third set of candidate resources based at least in part on a shaping pattern of the one or more quality metrics satisfying a quality tolerance threshold.

In a second aspect, alone or in combination with the first aspect, the quality tolerance threshold is associated with a quality tolerance range, and the shaping pattern of the one or more quality metrics satisfying the quality tolerance threshold includes the one or more quality metrics being within the quality tolerance range.

In a third aspect, alone or in combination with one or more of the first and second aspects, the quality tolerance threshold is based at least in part on the first aggregation level.

In a fourth aspect, alone or in combination with one or more of the first through third aspects, a quantity of the one or more quality metrics satisfying the quality tolerance threshold is associated with the first aggregation level.

In a fifth aspect, alone or in combination with one or more of the first through fourth aspects, the one or more respective CCEs include one or more interleaved CCEs that are mapped to one or more physical resource blocks.

In a sixth aspect, alone or in combination with one or more of the first through fifth aspects, the one or more physical resource blocks are discontinuous.

In a seventh aspect, alone or in combination with one or more of the first through sixth aspects, the first set of candidate resources includes one or more PDCCH candidate resources.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 140 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 7-12. Additionally, or alternatively, the apparatus 1500 may be configured to perform one or more processes described herein, such as process 1300 of FIG. 13, process 1400 of FIG. 14, or a combination thereof. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1504 may be co-located with the reception component 1502 in one or more transceivers.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The communication manager 1506 may identify one or more quality metrics associated with one or more respective CCEs of a first set of candidate resources that partially overlaps with a second set of candidate resources, wherein the first set of candidate resources is associated with a first aggregation level and the second set of candidate resources is associated with a second aggregation level. The communication manager 1506 may prune the second set of candidate resources based at least in part on a shaping pattern of the one or more quality metrics satisfying a quality tolerance threshold.

The communication manager 1506 may identify a first set of candidate resources that fully overlaps with one or more second sets of candidate resources, wherein the first set of candidate resources is associated with a first aggregation level and the one or more second sets of candidate resources are associated with a second aggregation level, wherein the first aggregation level is greater than the second aggregation level. The communication manager 1506 may perform, based at least in part on the first aggregation level being greater than the second aggregation level, a first decode operation on the first set of candidate resources before selectively performing one or more second decode operations on the one or more second sets of candidate resources.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a UE, comprising: identifying one or more quality metrics associated with one or more respective CCEs of a first set of candidate resources that partially overlaps with a second set of candidate resources, wherein the first set of candidate resources is associated with a first aggregation level and the second set of candidate resources is associated with a second aggregation level; and pruning the second set of candidate resources based at least in part on a shaping pattern of the one or more quality metrics satisfying a quality tolerance threshold.

Aspect 2: The method of Aspect 1, wherein the quality tolerance threshold is associated with a quality tolerance range, and wherein the shaping pattern of the one or more quality metrics satisfying the quality tolerance threshold includes the one or more quality metrics being within the quality tolerance range.

Aspect 3: The method of any of Aspects 1-2, wherein the quality tolerance threshold is based at least in part on the first aggregation level.

Aspect 4: The method of any of Aspects 1-3, wherein a quantity of the one or more quality metrics satisfying the quality tolerance threshold is associated with the first aggregation level.

Aspect 5: The method of any of Aspects 1-4, wherein the first set of candidate resources fully overlaps with one or more third sets of candidate resources associated with a third aggregation level.

Aspect 6: The method of Aspect 5, wherein the first aggregation level is greater than the third aggregation level, the method further comprising: performing, based at least in part on the first aggregation level being greater than the third aggregation level, a first decode operation on the first set of candidate resources before selectively performing a second decode operation on the one or more third sets of candidate resources.

Aspect 7: The method of any of Aspects 1-6, wherein the one or more respective CCEs include one or more interleaved CCEs that are mapped to one or more physical resource blocks.

Aspect 8: The method of Aspect 7, wherein the one or more physical resource blocks are discontinuous.

Aspect 9: A method of wireless communication performed by a UE, comprising: identifying a first set of candidate resources that fully overlaps with one or more second sets of candidate resources, wherein the first set of candidate resources is associated with a first aggregation level and the one or more second sets of candidate resources are associated with a second aggregation level, wherein the first aggregation level is greater than the second aggregation level; and performing, based at least in part on the first aggregation level being greater than the second aggregation level, a first decode operation on the first set of candidate resources before selectively performing one or more second decode operations on the one or more second sets of candidate resources.

Aspect 10: The method of Aspect 9, wherein the first set of candidate resources partially overlaps with a third set of candidate resources, and wherein the third set of candidate resources is associated with a third aggregation level, the method further comprising: identifying one or more quality metrics associated with one or more respective CCEs of the first set of candidate resources; and pruning the third set of candidate resources based at least in part on a shaping pattern of the one or more quality metrics satisfying a quality tolerance threshold.

Aspect 11: The method of Aspect 10, wherein the quality tolerance threshold is associated with a quality tolerance range, and wherein the shaping pattern of the one or more quality metrics satisfying the quality tolerance threshold includes the one or more quality metrics being within the quality tolerance range.

Aspect 12: The method of Aspect 10, wherein the quality tolerance threshold is based at least in part on the first aggregation level.

Aspect 13: The method of Aspect 10, wherein a quantity of the one or more quality metrics satisfying the quality tolerance threshold is associated with the first aggregation level.

Aspect 14: The method of Aspect 10, wherein the one or more respective CCEs include one or more interleaved CCEs that are mapped to one or more physical resource blocks.

Aspect 15: The method of Aspect 14, wherein the one or more physical resource blocks are discontinuous.

Aspect 16: The method of any of Aspects 9-15, wherein the first set of candidate resources includes one or more PDCCH candidate resources.

Aspect 17: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-16.

Aspect 18: An apparatus for wireless communication at a device, the apparatus comprising one or more memories and one or more processors coupled to the one or more memories, the one or more processors configured to cause the device to perform the method of one or more of Aspects 1-16.

Aspect 19: An apparatus for wireless communication, the apparatus comprising at least one means for performing the method of one or more of Aspects 1-16.

Aspect 20: A non-transitory computer-readable medium storing code for wireless communication, the code comprising instructions executable by one or more processors to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

Aspect 22: A device for wireless communication, comprising memory, and one or more processors coupled to the memory, the memory comprising instructions executable by the one or more processors to cause the device to perform the method of one or more of Aspects 1-16.

Aspect 23: A device for wireless communication, the device comprising a processing system that includes one or more processors and one or more memories coupled with the one or more processors, the processing system configured to cause the device to perform the method of one or more of Aspects 1-16.

Aspect 24: An apparatus for wireless communication at a device, the apparatus comprising one or more memories and one or more processors coupled to the one or more memories, the one or more processors individually or collectively configured to cause the device to perform the method of one or more of Aspects 1-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors coupled to the one or more memories, the one or more memories including instructions executable by the one or more processors to cause the UE to:
identify one or more quality metrics associated with one or more respective control channel elements (CCEs) of a first set of candidate resources that partially overlaps with a second set of candidate resources, wherein the first set of candidate resources is associated with a first aggregation level and the second set of candidate resources is associated with a second aggregation level; and
prune the second set of candidate resources based at least in part on a shaping pattern of the one or more quality metrics satisfying a quality tolerance threshold.

2. The UE of claim 1, wherein the quality tolerance threshold is associated with a quality tolerance range, and wherein the shaping pattern of the one or more quality metrics satisfying the quality tolerance threshold includes the one or more quality metrics being within the quality tolerance range.

3. The UE of claim 1, wherein the quality tolerance threshold is based at least in part on the first aggregation level.

4. The UE of claim 1, wherein a quantity of the one or more quality metrics satisfying the quality tolerance threshold is associated with the first aggregation level.

5. The UE of claim 1, wherein the first set of candidate resources fully overlaps with one or more third sets of candidate resources associated with a third aggregation level.

6. The UE of claim 5, wherein the first aggregation level is greater than the third aggregation level, and wherein the one or more memories further include instructions executable by the one or more processors to cause the UE to:
perform, based at least in part on the first aggregation level being greater than the third aggregation level, a first decode operation on the first set of candidate resources before selectively performing a second decode operation on the one or more third sets of candidate resources.

7. The UE of claim 1, wherein the one or more respective CCEs include one or more interleaved CCEs that are mapped to one or more physical resource blocks.

8. The UE of claim 7, wherein the one or more physical resource blocks are discontinuous.

9. A UE for wireless communication, comprising:
one or more memories; and
one or more processors coupled to the one or more memories, the one or more memories including instructions executable by the one or more processors to cause the UE to:
identify a first set of candidate resources that fully overlaps with one or more second sets of candidate resources, wherein the first set of candidate resources is associated with a first aggregation level and the one or more second sets of candidate resources are associated with a second aggregation level, wherein the first aggregation level is greater than the second aggregation level; and
perform, based at least in part on the first aggregation level being greater than the second aggregation level, a first decode operation on the first set of candidate resources before selectively performing one or more second decode operations on the one or more second sets of candidate resources.

10. The UE of claim 9, wherein the first set of candidate resources partially overlaps with a third set of candidate resources, wherein the third set of candidate resources is associated with a third aggregation level, and wherein the one or more memories further include instructions executable by the one or more processors to cause the UE to:
identify one or more quality metrics associated with one or more respective control channel elements (CCEs) of the first set of candidate resources; and
prune the third set of candidate resources based at least in part on a shaping pattern of the one or more quality metrics satisfying a quality tolerance threshold.

11. The UE of claim 10, wherein the quality tolerance threshold is associated with a quality tolerance range, and wherein the shaping pattern of the one or more quality metrics satisfying the quality tolerance threshold includes the one or more quality metrics being within the quality tolerance range.

12. The UE of claim 10, wherein the quality tolerance threshold is based at least in part on the first aggregation level.

13. The UE of claim 10, wherein a quantity of the one or more quality metrics satisfying the quality tolerance threshold is associated with the first aggregation level.

14. The UE of claim 10, wherein the one or more respective CCEs include one or more interleaved CCEs that are mapped to one or more physical resource blocks.

15. The UE of claim 14, wherein the one or more physical resource blocks are discontinuous.

16. The UE of claim 9, wherein the first set of candidate resources includes one or more physical downlink control channel (PDCCH) candidate resources.

17. A method of wireless communication performed by a user equipment (UE), comprising:
identifying one or more quality metrics associated with one or more respective control channel elements (CCEs) of a first set of candidate resources that partially overlaps with a second set of candidate resources, wherein the first set of candidate resources is associated with a first aggregation level and the second set of candidate resources is associated with a second aggregation level; and
pruning the second set of candidate resources based at least in part on a shaping pattern of the one or more quality metrics satisfying a quality tolerance threshold.

18. The method of claim 17, wherein the quality tolerance threshold is associated with a quality tolerance range, and wherein the shaping pattern of the one or more quality metrics satisfying the quality tolerance threshold includes the one or more quality metrics being within the quality tolerance range.

19. The method of claim 17, wherein the quality tolerance threshold is based at least in part on the first aggregation level.

20. The method of claim 17, wherein a quantity of the one or more quality metrics satisfying the quality tolerance threshold is associated with the first aggregation level.

21. The method of claim 17, wherein the first set of candidate resources fully overlaps with one or more third sets of candidate resources associated with a third aggregation level.

22. The method of claim 21, wherein the first aggregation level is greater than the third aggregation level, the method further comprising:
performing, based at least in part on the first aggregation level being greater than the third aggregation level, a first decode operation on the first set of candidate resources before selectively performing a second decode operation on the one or more third sets of candidate resources.

23. The method of claim 17, wherein the one or more respective CCEs include one or more interleaved CCEs that are mapped to one or more physical resource blocks.

24. A method of wireless communication performed by a user equipment (UE), comprising:
identifying a first set of candidate resources that fully overlaps with one or more second sets of candidate resources, wherein the first set of candidate resources is associated with a first aggregation level and the one or more second sets of candidate resources are associated with a second aggregation level, wherein the first aggregation level is greater than the second aggregation level; and
performing, based at least in part on the first aggregation level being greater than the second aggregation level, a first decode operation on the first set of candidate resources before selectively performing one or more second decode operations on the one or more second sets of candidate resources.

25. The method of claim 24, wherein the first set of candidate resources partially overlaps with a third set of candidate resources, and wherein the third set of candidate resources is associated with a third aggregation level, the method further comprising:
identifying one or more quality metrics associated with one or more respective control channel elements (CCEs) of the first set of candidate resources; and
pruning the third set of candidate resources based at least in part on a shaping pattern of the one or more quality metrics satisfying a quality tolerance threshold.

26. The method of claim 25, wherein the quality tolerance threshold is associated with a quality tolerance range, and wherein the shaping pattern of the one or more quality metrics satisfying the quality tolerance threshold includes the one or more quality metrics being within the quality tolerance range.

27. The method of claim 25, wherein the quality tolerance threshold is based at least in part on the first aggregation level.

28. The method of claim 25, wherein a quantity of the one or more quality metrics satisfying the quality tolerance threshold is associated with the first aggregation level.

29. The method of claim 25, wherein the one or more respective CCEs include one or more interleaved CCEs that are mapped to one or more physical resource blocks.

30. The method of claim 29, wherein the one or more physical resource blocks are discontinuous.
